(19) United States
(12) Patent Application Publication
(10) Pub. No.: US 2020/0346254 A1
(43) Pub. Date: Nov. 5, 2020

(54) ULTRASONIC CONCRETE FORM CLEANING METHOD

(71) Applicants: Michael Opatril, Glyndon, MN (US); Justin Thompson, Horace, ND (US)

(72) Inventors: Michael Opatril, Glyndon, MN (US); Justin Thompson, Horace, ND (US)

(21) Appl. No.: 16/864,636

(22) Filed: May 1, 2020

Related U.S. Application Data
(60) Provisional application No. 62/841,593, filed on May 1, 2019.

(51) Int. Cl. B08B 3/12; B08B 3/08; B06B 1/02; C11D 7/08

(52) U.S. Cl. CPC B08B 3/12; B08B 3/08; B06B 2201/74; C11D 7/08; B08B 2203/007; B06B 1/0215

(57) ABSTRACT

A method of cleaning concrete forms includes preparing a liquid comprising a mixture of water and a chemical, and heating the liquid to a temperature of about 180 degrees Fahrenheit. The concrete form is placed into the liquid, and an ultrasonic pressure wave is imparted into the liquid in the tank using an ultrasonic transducer powered by a generator.

### RELATED APPLICATIONS

The present application is based on and claims the benefit to U.S. Provisional Application No. 62/841,593, filed on May 1, 2019 entitled, ULTRASONIC CONCRETE FORM CLEANING METHOD the contents of which are hereby incorporated by reference in their entireties.

### FIELD

This disclosure is directed toward concrete forms, and more specifically, to cleaning concrete residue from concrete equipment such as forms.

### BACKGROUND

Concrete form panels are typically made from aluminum or steel with moisture resistant wood. Forms are concrete panels for use to construct a foundation of a concrete structural wall.

When the concrete has cured sufficiently to remove the forms, there is often an amount of residual concrete left on the form edges. There is no good way to clean form panels once the concrete has dried and the forms are removed.

One traditional way of cleaning concrete forms is by scraping and chipping away concrete residue. This method is labor intensive, time consuming, and is likely to cause damage to the forms. Further, scraping and chipping may leave smaller amounts of residue that later stick to concrete when the forms are used later. Machines using sanding or other abrading belts and rollers may also be used, or blasting with high-pressure water or the like. These are also labor intensive, and are messy and potentially hazardous.

Another way of cleaning concrete forms is applying a cleaning solution combined with a release agent during use of the forms. Such solutions may be formulated as a release agent combined with a cleaner, and usually require multiple applications over the course of weeks of use and reuse of the forms before cleaning becomes effective.

Yet another way of cleaning concrete forms is by soaking in a cleaning solution. Such solutions are formulated to soften and eventually loosen or even dissolve concrete deposits over time. Such solutions typically require a soaking of on the order of 48 hours or more to remove residual concrete. Further, since forms can be large and quite heavy, on the order of 90 pounds or more, much soaking space may be required for the process of loosening concrete residue.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

In one embodiment, a method of cleaning concrete residue from forms for concrete includes placing a concrete form with residual concrete into a tank containing a liquid, and ultrasonically cleaning the residual concrete with ultrasonic energy imparted into the liquid.

Additional aspects of ultrasonic cleaning include at least one of preparing a mixture of citric acid, surfactant, and water at a predetermined ratio (1-5 oz/gal of citric acid in one embodiment); heating the mixture to a temperature of about 180 degrees Fahrenheit; and applying the ultrasonic energy at a predetermined frequency.

Additional aspects of ultrasonic cleaning include preparing a mixture of at least citric acid, surfactant, and water at a predetermined ratio, heating the mixture to a temperature of about 180 degrees Fahrenheit, and applying the ultrasonic energy at a predetermined frequency.

In another embodiment, a method of cleaning concrete forms includes preparing a liquid comprising a mixture of water and a chemical, and heating the liquid to a temperature of about 140-180 degrees Fahrenheit. A concrete form is placed into the liquid. An ultrasonic pressure wave is introduced into the liquid in the tank using an ultrasonic transducer powered by a generator.

In another embodiment, a system for ultrasonic cleaning of concrete forms includes a tank and a liquid containing a mixture of water, surfactant, and a chemical contained in the tank. A plurality of transducers arrayed within the tank, and are configured to clean a concrete form placed into the tank using a method. The method comprises placing the concrete form with residual concrete into the tank containing the liquid, ultrasonically cleaning the residual concrete with ultrasonic energy imparted into the liquid by the transducers.

This summary is not intended to describe each disclosed embodiment or every implementation of concrete form cleaning as described herein. Many other novel advantages, features, and relationships will become apparent as this description proceeds. The figures and the description that follow more particularly exemplify illustrative embodiment.

### BRIEF DESCRIPTION OF DRAWINGS

FIG. 1 is a perspective view of a tank on which embodiments of the present disclosure may be practiced.

FIG. 2 is a partial cutaway view of a portion of the tank of FIG. 1.

FIG. 3 is a flow chart diagram of a method according to an embodiment of the present disclosure.

### DETAILED DESCRIPTION

Embodiments of the present disclosure are directed toward efficient, quick, and cost effective methods for cleaning concrete equipment with residual concrete. Concrete equipment includes, but is not limited to, concrete forms, concrete truck chutes, concrete tools, and other equipment that may have concrete residue. A faster, more efficient way of cleaning concrete forms is provided by embodiments of the present disclosure. Some embodiments use a heated mixture of a chemical such as citric acid, a surfactant, and water, and ultrasonic energy introduced into the mixture at a predetermined frequency or range of frequencies to ultrasonically clean concrete residue from the concrete forms. Citric acid is used at a rate of about 1-5 ounces per gallon of water in one embodiment. While citric acid is discussed, it should be understood that a different chemical or multiple chemicals may be used in the mixture depending upon the concrete residue to be removed from the concrete forms.

Ultrasonic energy exists in a liquid as alternate rarefactions and compressions of the liquid. During rarefaction, small vacuum cavities are formed which collapse, or implode, during compression. This continuing rapid process, called cavitation, is responsible for the scrubbing effect which produces ultrasonic cleaning. Three factors affecting the scrubbing action are the degree of liquid degassing, the ultrasonic frequency and the chemical characteristics of the liquid at specific temperatures.

Degassing is the removal of unwanted air from the liquid, typically found in fresh tap water. As the cavities form, they fill with the unwanted air forming bubbles, which resist collapse and tend to remain suspended in the liquid. These bubbles act as “shock absorbers,” which materially reduce cleaning efficiency. The amount of air can be reduced by periodically switching off, or modulating, the sound energy to permit adjacent bubbles to coalesce, float to the surface, and escape. The type of modulation is important, for the correct balance between degassing and cleaning efficiency must be selected for each cleaning application.

Frequency affects cleaning efficiency by determining the cavity size. Low frequencies generate large but relatively few cavities with high cleaning power. High frequencies generate a great number of small cavities with good penetrating capability. The selection of the correct frequency is difficult, for it varies with each cleaning application. The frequency also affects degassing, with 40 kHz nearly optimum.

Cleaning efficiency is also affected by the chemical and physical characteristics of the liquid. For best cleaning, the liquid must chemically soften the concrete residue, yet maintain effective cavitation and provide the desired characteristics for rinsing and drying the cleaned concrete forms. Ultrasonic cleaning solutions are broadly characterized as aqueous or nonaqueous. Final selection is dependent upon the overall process considerations for the cleaning application.

The ultrasonic energy is created within a liquid by means of transducers, which convert electrical energy into acoustic energy. These transducers are similar in function to a radio speaker except they function at ultrasonic frequencies (on the order of 40,000 Hz, although higher or lower frequencies in the ultrasonic range above 20,000 Hertz may be used without departing from the scope of the disclosure) and transmit acoustic energy to a liquid rather than to air. The transducers consist of vibrating elements (piezoelectric disc) bolted between thick metal plates. The transducers are bonded to the side or underside of the tanks containing the cleaning liquid or are encased in stainless steel for immersion within a liquid. For reliability, many transducer modules are uniformly distributed over the tank side or bottom rather than having a single transducer in the center of the tank working very hard. An electronic generator energizes the transducers. The generator transforms the electrical energy from the wall outlet into a suitable electrical form for efficiently energizing the transducers at the desired frequencies. All ultrasonic cleaning systems consist of the four fundamental components; transducer, generator, container for liquid, and cleaning liquid. The performance and reliability of the system depends upon the design and construction of the transducers and generators. The overall effectiveness of the cleaning is dependent upon the cleaning liquid. The size of the tank is dependent upon the size or quantity of the concrete forms being cleaned. The number of transducers and generators is determined by the tank size. The choice of cleaning liquid including the chemical(s) mixed with water depends upon the concrete forms being cleaned and contaminant to be removed.

Embodiments of the present disclosure provide methods and apparatus for quickly and effectively cleaning concrete forms. In one embodiment, ultrasonic cleaning in a tank is used for cleaning concrete forms in a bath of liquid. In one embodiment, ultrasonic energy is applied to liquid in the tank to create pressure waves in the liquid. Concrete forms are placed in the tank and subjected to the ultrasonic pressure waves, which cause the residual concrete to be removed from the concrete forms due to the ultrasonic energy in the bath.

Ultrasonic cleaning operates under the principle of rarefaction and compression induced in a liquid by ultrasonic sound waves introduced into the liquid. The rarefaction and compression leads to cavitation, which increase the cleaning power of the liquid. Rarefaction introduces small vacuum cavities in the liquid, and compression collapses the vacuum cavities, resulting in cavitation that provides a scrubbing action in the liquid. Factors that affect the quality of scrubbing action in a liquid include the degree of liquid degassing, the ultrasonic frequency, and the chemical characteristics of the liquid at specific temperatures.

Energy in the form of ultrasonic sound waves is introduced into the liquid, for example, using transducer(s) powered by a generator. The transducer(s), powered by the generator emit sound waves into the liquid, inducing the rarefaction and compression in the liquid in the tank.

In one embodiment, the liquid for the tank comprises a mixture of water and a chemical such as citric acid. The cavitation process within the liquid acts as a scrubber for the residual concrete on the forms. In one embodiment, the liquid in the ultrasonic tank is heated, in one embodiment to 140-180 degrees Fahrenheit or hotter.

FIG. 1 shows a perspective diagram of a system 100 for ultrasonic cleaning ultrasonic cleaning of concrete forms. System 100 includes tank 102 holding a liquid 104 used for ultrasonic cleaning. Transducers 106 are arrayed at a bottom of the tank, although transducers 106 need not be at the bottom, but may alternatively be positioned elsewhere to introduce ultrasonic energy to liquid 104 in tank 102.

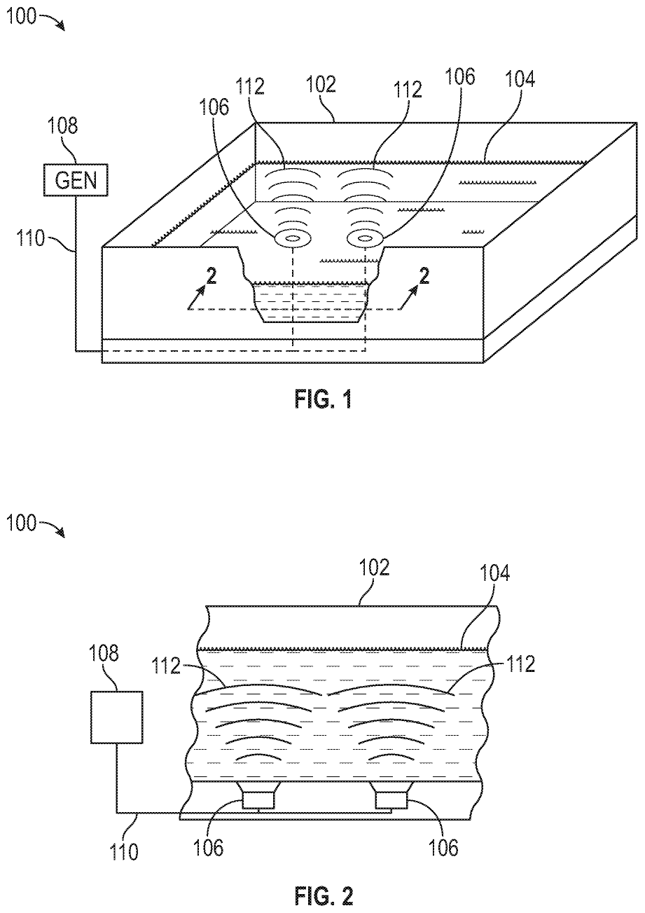

FIG. 2 shows a partial cutaway view of a portion of the system 100 of FIG. 1. Ultrasonic transducers 106 are shown mounted at a bottom of the tank 102, arranged to emit ultrasonic energy into liquid 104 in the tank 102. The ultrasonic waves 112 induced by the transducers 102 overlap to provide ultrasonic rarefaction and compression within the liquid 104 in tank 102. This results in the ultrasonic cleaning action described above.

One basic method for cleaning residual concrete from concrete forms comprises placing a concrete form (such as a metal form) with residual concrete deposits into a tank containing a liquid, and ultrasonically cleaning the residual concrete with ultrasonic energy imparted into the liquid. The liquid may comprise a mixture of a chemical, such as citric acid and water. The liquid may be heated before the application of ultrasonic energy, such as to a temperature of about 180 degrees Fahrenheit, or hotter. Transducers are used in one embodiment to provide ultrasonic energy in the form of ultrasonic waves. A frequency or range of frequencies of the ultrasonic energy may be chosen to address specific deposits of concrete residue, such as thick or thin, spotty or more fully coated forms, and the like. A combination of ultrasonic frequency, composition of the liquid, and temperature may be chosen depending on the mixture of concrete, such as cement to aggregate, or the amount of residual concrete including its thickness or area, or the like. Further, a plurality of pulses of energy, at a frequency or over a range of frequencies, and/or in combination with heat and different chemicals of the liquid mixture, may be propagated into in the liquid within the tank. to effect cleaning of concrete residue from concrete forms.

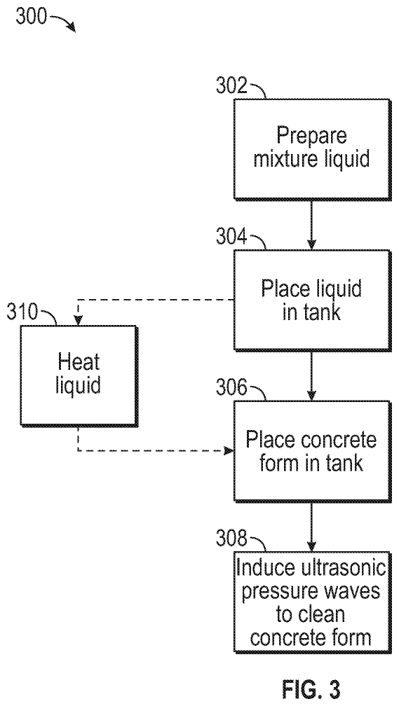

A more detailed method 300 according to an embodiment of the disclosure is shown in flow chart form in FIG. 3. Method 300 comprises, in one embodiment, preparing a liquid comprising a mixture of water and a chemical in block 302. In one embodiment, the chemical is citric acid. The liquid is placed in a tank in block 304. In one optional embodiment, the liquid comprises a water and chemical mix that is heated to a temperature of about 140-180 degrees Fahrenheit as shown in optional block 310. A concrete form with residual concrete deposits thereon is placed into the tank in block 306. An ultrasonic pressure wave is induced in the liquid in the tank to remove the residual concrete deposits in block 308. In one embodiment, ultrasonic energy is created within the liquid with an ultrasonic generator powering transducers as described above. The transducers impart ultrasonic energy into the liquid.

In one embodiment, a concrete form may be effectively cleaned in the tank containing the liquid subjected to ultrasonic energy in about 20 minutes, compared to traditional soaking chemical cleaning time of on the order of 48 hours, or extensive labor-intensive manual scrubbing and chipping of material.

Cleaning one concrete form panel at a time, for about 20 minutes, is far faster even than cleaning multiple panels over a 48 hour period, using less labor and reducing cleaning time as well.

The mixture of chemical to water may be varied for the amount of residual concrete deposit on the forms, the material of the forms, or the like, without departing from the scope of the disclosure. For example, for heavier residual concrete deposits may use a different concentration of chemical in water, or use a different chemical.

Moreover, the execution of the embodiments of the disclosure are also possible in a variety of variations of the examples shown here and aspects of the disclosure highlighted above.

What is claimed is:

1. A method of cleaning concrete residue from forms for concrete, comprising:
placing a concrete form with residual concrete into a tank containing a liquid; and
ultrasonically cleaning the residual concrete with ultrasonic energy imparted into the liquid.

2. The method of claim 1, wherein cleaning further comprises:
preparing a liquid comprising a mixture of citric acid, surfactant, and water at a predetermined ratio.

3. The method of claim 2, wherein cleaning further comprises:
heating the liquid to a temperature of about 140-180 degrees Fahrenheit.

4. The method of claim 2, wherein cleaning further comprises applying the ultrasonic energy at a predetermined frequency or range of frequencies.

5. The method of claim 4, wherein the ultrasonic energy is applied at about 40,000 Hertz.

6. The method of claim 1, wherein cleaning further comprises:
preparing a liquid comprising a mixture of citric acid, surfactant, and water at a predetermined ratio;
heating the liquid to a temperature of about 140-180 degrees Fahrenheit; and
applying the ultrasonic energy at a predetermined frequency.

7. The method of claim 1, wherein the ultrasonic energy is imparted into the liquid in pulses.

8. The method of claim 2, wherein citric acid is used in a ratio of about 1-5 ounces per gallon of water.

9. A method of cleaning concrete forms, comprising:
preparing a liquid comprising a mixture of water and a chemical;
heating the liquid to a temperature of about 140-180 degrees Fahrenheit;
placing a concrete form into the liquid; and
inducing an ultrasonic pressure wave in the liquid in the tank using an ultrasonic transducer powered by a generator.

10. The method of claim 9, wherein preparing a liquid comprises preparing a mixture of citric acid, surfactant, and the water at a predetermined ratio.

11. The method of claim 10, wherein citric acid is used in a ratio of about 1-5 ounces per gallon of water.

12. The method of claim 9, wherein introducing an ultrasonic pressure wave further comprises applying ultrasonic energy with the ultrasonic transducer at a predetermined frequency.

13. The method of claim 12, wherein applying ultrasonic energy comprises applying energy at about 40,000 Hertz.

14. The method of claim 9, wherein introducing an ultrasonic pressure wave further comprises applying ultrasonic energy with the ultrasonic transducer over a range of frequencies.

15. The method of claim 9, wherein the ultrasonic energy is imparted into the liquid in pulses.

16. A system for ultrasonic cleaning of concrete forms, comprising:
a tank;
a liquid containing a mixture of water, surfactant, and a chemical contained in the tank;
a plurality of transducers arrayed within the tank, configured to clean a concrete form placed into the tank using a method comprising:
placing the concrete form with residual concrete into the tank containing the liquid; and
ultrasonically cleaning the residual concrete with ultrasonic energy imparted into the liquid by the transducers.
